(19) United States
(12) Patent Application Publication
(10) Pub. No.: US 2022/0379621 A1
(43) Pub. Date: Dec. 1, 2022

(54) LIQUID CONTAINER AND INTRODUCTION MEMBER

(71) Applicant: CANON KABUSHIKI KAISHA, Tokyo (JP)

(72) Inventors: Hiroshi Inomata, Kanagawa (JP); Yu Katano, Kanagawa (JP); Ken Ikegame, Kanagawa (JP); Hirofumi Ota, Kanagawa (JP)

(21) Appl. No.: 17/746,828

(22) Filed: May 17, 2022

(30) Foreign Application Priority Data
May 25, 2021 (JP) 2021-087565

(51) Int. Cl. B41J 2/175

(52) U.S. Cl. CPC B41J 2/17513; B41J 2002/17516

(57) ABSTRACT

The object is to provide a liquid container capable of supplying liquid to a liquid ejection apparatus with simple configuration. Liquid container 100 has liquid containing bag 120 and an introduction member. The introduction member includes the first and second liquid introduction members. The first introduction member has the first spacer unit and the first coupling unit integrally connected to the first spacer unit in which the first groove for letting liquid flow to a liquid lead-out unit is formed. The second introduction member has the second spacer unit and the second coupling unit integrally connected to the second spacer unit in which the second groove for letting liquid flow to the liquid lead-out unit is formed. The first and second liquid introduction members are adjoined so that the surface on which the first groove is formed and the surface on which the second groove is formed face each other.

### BACKGROUND OF THE INVENTION

### Field of the Invention

The technique of the present disclosure relates to a liquid container and an introduction member for supplying liquid to a liquid ejection apparatus.

### Description of the Related Art

Japanese Patent Laid-Open No. 2018-65373 discloses a liquid container for supplying liquid taken from a spacer to a liquid ejection apparatus via a liquid lead-out pipe. This spacer has a predetermined height and is equipped with an inlet for liquid intake. Even if the liquid in the bag is reduced and the bag is gradually crushed by continuing the liquid intake, the space for taking the liquid is maintained around the inlet by the spacer that is installed, so that it is possible to prevent the inlet from being blocked by the bag, which makes the liquid intake impossible.

However, as in Japanese Patent Laid-Open No. 2018-65373, a liquid container having a complicated structure leads to an increase in the number of parts, an increase in the number of steps for the assemblage, and an increase in the cost of a liquid lead-out unit.

In order to solve such a problem, the technique of the present disclosure aims to provide a liquid container capable of supplying liquid to a liquid ejection apparatus with a simple configuration.

### SUMMARY OF THE INVENTION

The technique of the present disclosure relates to a liquid container including: a liquid containing bag configured to contain liquid; and an introduction member arranged inside the liquid containing bag for introducing the liquid to a liquid lead-out unit, wherein the introduction member includes a first liquid introduction member and a second liquid introduction member which is adjoined to the first liquid introduction member, wherein the first liquid introduction member is equipped with a first spacer unit, in which a first liquid intake port for taking the liquid is formed, and a first coupling unit, which is integrally connected to the first spacer unit and in which a first groove for letting the liquid taken from the first liquid intake port flow to the liquid lead-out unit is formed, wherein the second liquid introduction member is equipped with a second spacer unit, in which a second liquid intake port for taking the liquid is formed, and a second coupling unit, which is integrally connected to the second spacer unit and in which a second groove for letting the liquid taken from the second liquid intake port flow to the liquid lead-out unit is formed, and wherein the first liquid introduction member and the second liquid introduction member are adjoined so that a surface on which the first groove is formed and a surface on which the second groove is formed face each other.

Further features of the present invention will become apparent from the following description of exemplary embodiments with reference to the attached drawings.

### BRIEF DESCRIPTION OF THE DRAWINGS

FIG. 1 is an external perspective view illustrating an outline of a liquid ejection apparatus;

FIG. 2A and FIG. 2B are diagrams illustrating an outline of a liquid container;

FIG. 3 is an external perspective view illustrating an outline of a liquid conveyance member;

FIG. 4A and FIG. 4B are diagrams illustrating an outline of a liquid introduction member;

FIG. 5 is a cross-sectional view taken along line V-V of FIG. 4A;

FIG. 6A to FIG. 6C are external perspective views illustrating an outline of another liquid introduction member;

FIG. 7A and FIG. 7B are external perspective views illustrating an outline of constituent parts of the liquid introduction member;

FIG. 8 is an external perspective view illustrating an outline of the liquid introduction member;

FIG. 9A and FIG. 9B are external perspective views illustrating an outline of constituent parts of another liquid introduction member;

FIG. 10A and FIG. 10B are diagrams illustrating an outline of a liquid lead-out member;

FIG. 11A and FIG. 11B are cross-sectional views illustrating an outline of the liquid lead-out member;

FIG. 12A to FIG. 12C are diagrams illustrating an outline of a liquid introduction member;

FIG. 13 is a cross-sectional view illustrating an outline of a liquid lead-out member;

FIG. 14 is an external perspective view illustrating an outline of a liquid conveyance member;

FIG. 15A and FIG. 15B are external perspective views illustrating an outline of half-split bodies; and

FIG. 16 is an external perspective view illustrating an outline of a liquid conveyance member.

### DESCRIPTION OF THE EMBODIMENTS

Hereinafter, an explanation will be given of embodiments for implementing the technique of the present disclosure with reference to the drawings. Note that the following embodiments do not limit the invention according to the scope of the patent claims, and all combinations of the characteristics explained in the embodiments are not necessarily essential to the solution of the invention.

### First Embodiment

Hereinafter, the first embodiment according to the technique of the present disclosure will be explained.

### <Liquid Ejection Apparatus>

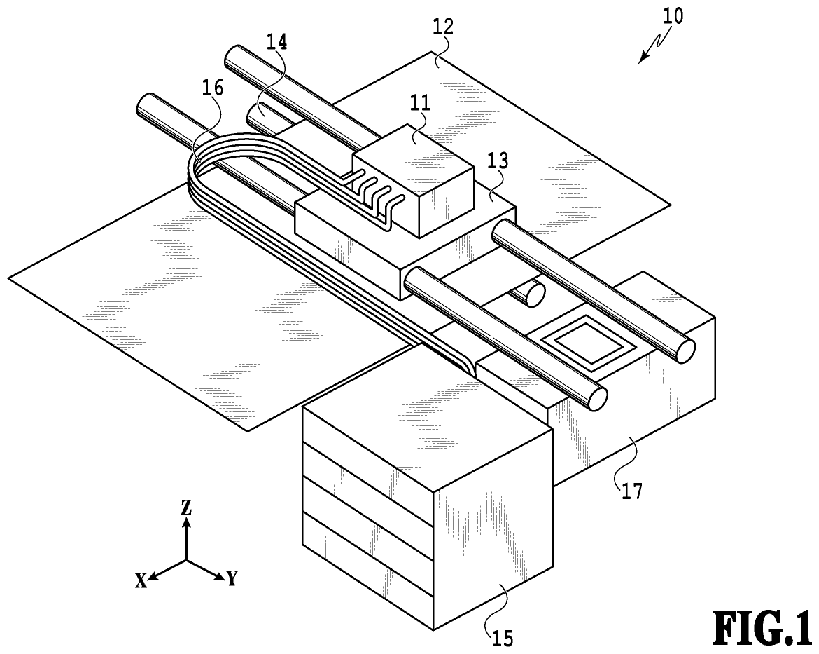

FIG. 1 is an external perspective view illustrating an outline of the liquid ejection apparatus 10 according to the present embodiment. As illustrated in FIG. 1, the liquid ejection apparatus 10 includes the liquid ejection head 11, the recording sheet 12, the carriage 13, the conveyance roller 14, the liquid supply unit 15, the liquid supply tube 16, and the recovery unit 17.

The liquid ejection apparatus 10 repeats reciprocal movement of the liquid ejection head 11 (main scanning) and conveyance of the recording sheet 12, which is a recording medium, on a per a predetermined pitch basis (sub scanning). By causing liquid (for example, ink or the like) of multiple colors to be selectively ejected from the liquid ejection head 11 in synchronization with these movements so that the liquid lands on the recording sheet 12 which is a recording medium, characters, symbols, images, etc., will be formed. Examples of the liquid ejection apparatus 10 include an inkjet printer, etc. Note that the recording medium may be anything as long as an ink droplet can be landed to form an image. For example, recording media of various materials and forms such as paper, a cloth, an optical disk label side, a plastic sheet, an OHP sheet, and an envelope can be used.

The liquid ejection head 11 is supported by two guide rails in a free-to-slide manner and is removably mounted on the carriage 13 which reciprocates on a straight line along the guide rails by a driving mechanism (not illustrated in the drawings) such as a motor.

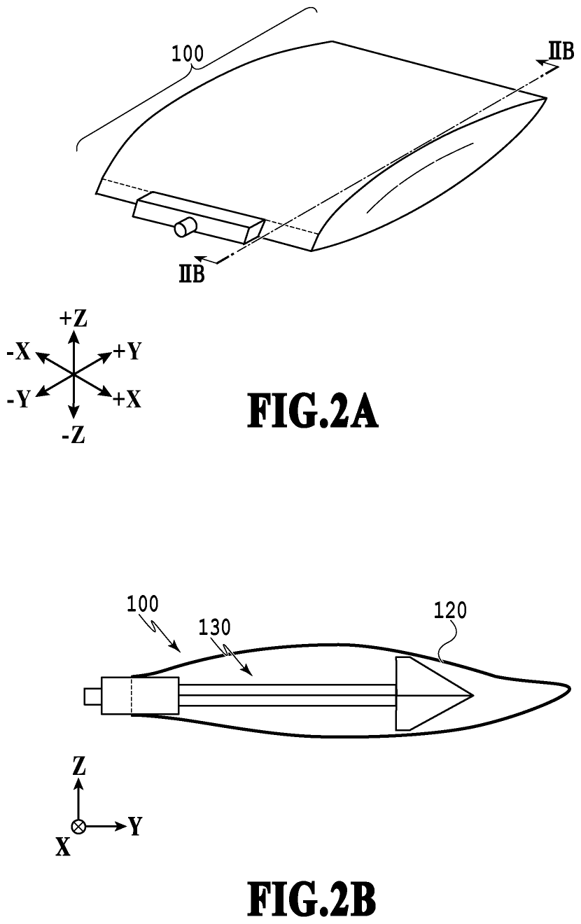

The recording sheet 12 on which the liquid ejected from the liquid ejection unit of the liquid ejection head 11 lands is made to face the liquid ejection plane of the liquid ejection head 11 and conveyed by the conveyance roller 14, which is a conveyance mechanism, in the direction that intersects the movement direction of the carriage 13. The liquid ejection head 11 has multiple nozzle arrays for ejecting liquid of different colors as the multiple liquid ejection units. The multiple independent liquid containers 100 (see FIG. 2A and FIG. 2B) having a liquid lead-out member for leading out liquid, which corresponds to the color of the liquid ejected from the liquid ejection head 11, are removably mounted on the liquid supply unit 15.

The liquid supply unit 15 and the liquid ejection head 11 are connected via the multiple liquid supply tubes 16 corresponding to the respective colors of the liquids. By mounting the liquid containers 100 inside the liquid supply unit 15, the liquids of the respective colors stored in the liquid containers 100 can be independently supplied to each nozzle array of the liquid ejection head 11. The recovery unit 17 is arranged so as to face the liquid ejection plane of the liquid ejection head 11 in the non-recording area, which is within the range of the reciprocal movement of the liquid ejection head 11 and outside the passage range of the recording sheet 12.

The recovery unit 17 has a cap unit for capping the liquid ejection plane of the liquid ejection head 11, a suction mechanism for forcibly suctioning the liquid in a state where the liquid ejection plane is capped, a cleaning blade for wiping the soiling on the liquid ejection plane, etc. The suction operation described above is performed by this recovery unit 17 prior to the recording operation of this liquid ejection apparatus 10. Accordingly, even in a case where this liquid ejection apparatus 10 is operated after being uncontrolled for a long period of time, both or either one of the residual bubbles in the liquid ejection units of the liquid ejection head 11 and the thickened liquid in the vicinity of the injection ports can be removed by performing the recovery process with the recovery unit 17. Accordingly, the injection characteristics of the liquid ejection head 11 are maintained.

### <Liquid Container>

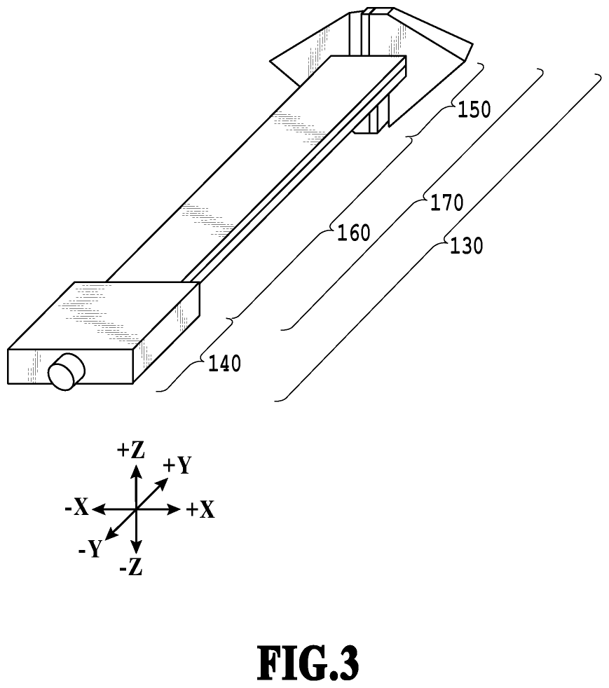

Subsequently, the configuration of the liquid containers 100 according to the present embodiment will be explained with reference to FIG. 2A and FIG. 2B and FIG. 3.

FIG. 2A and FIG. 2B are diagrams illustrating an outline of the liquid container 100 of the present embodiment. FIG. 2A is an external perspective view illustrating an outline of the liquid container 100. As described above, the liquid container 100 is mounted on the liquid supply unit 15 (see FIG. 1) and supplies liquid to the liquid ejection units of the liquid ejection head 11. FIG. 2B is a cross-sectional view taken along line IIb-IIb of FIG. 2A. As illustrated in FIG. 2B, the liquid container 100 includes the liquid containing bag 120 and the liquid conveyance member 130 contained in the liquid containing bag 120.

### <Liquid Conveyance Member>

FIG. 3 is an external perspective view illustrating an outline of the liquid conveyance member 130. The liquid conveyance member 130 includes the liquid introduction member 170 and the liquid lead-out member 140. As illustrated in FIG. 3, the liquid lead-out member 140 is mounted at the tip of the liquid introduction member 170. Further, the liquid conveyance member 130 is a member that conveys the liquid in the liquid containing bag 120 to the liquid ejection apparatus 10. The material of the liquid conveyance member 130 can be a synthetic resin such as polyethylene or polypropylene. In the present embodiment, the explanation will be continued on the premise that the material of the liquid conveyance member 130 is polypropylene.

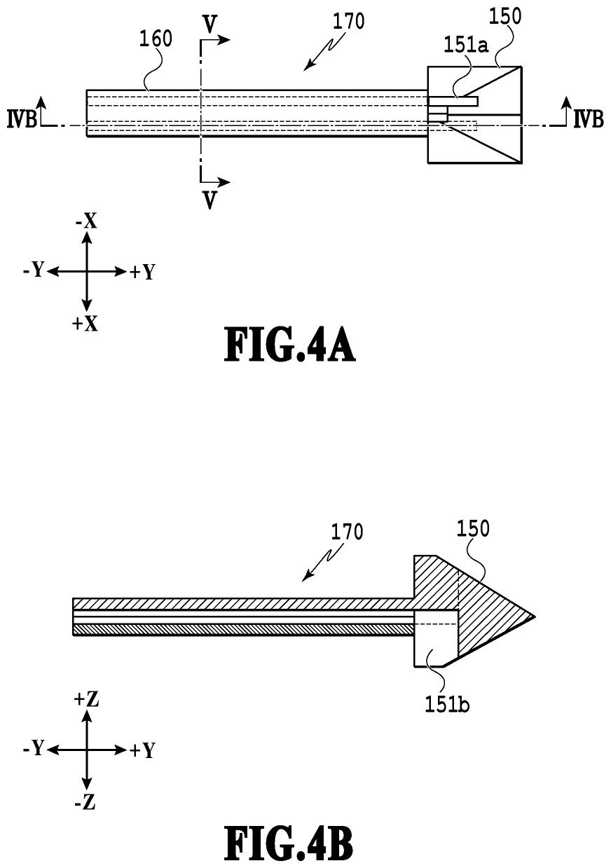

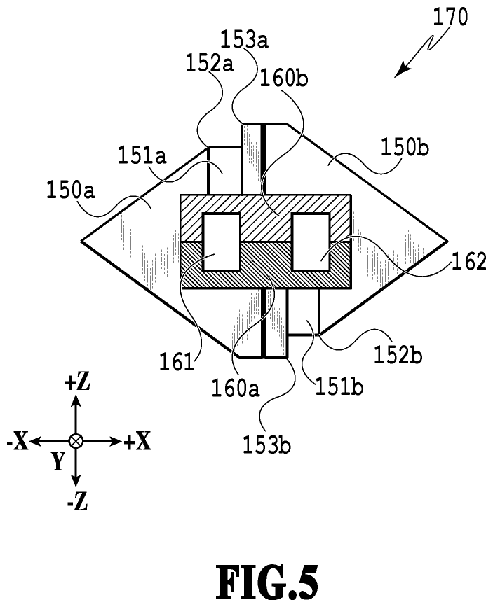

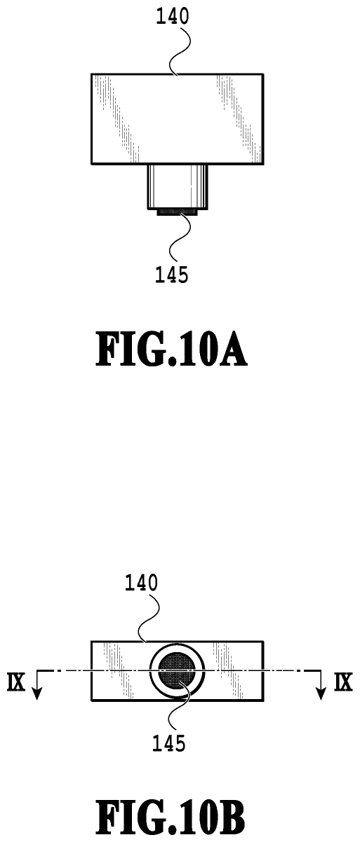

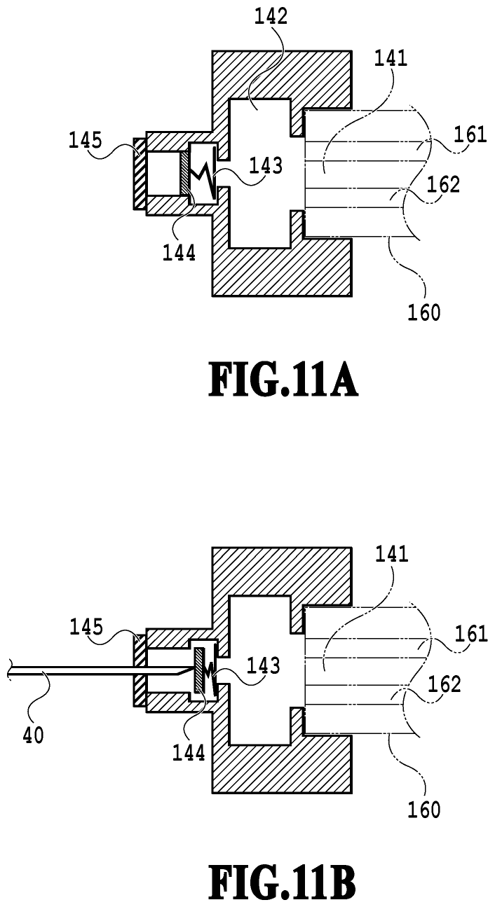

The liquid introduction member 170 includes the spacer unit 150 and the coupling unit 160. Further, the liquid introduction member 170 has a function of introducing the liquid taken from the spacer unit 150 to the liquid lead-out member 140 through a flow path in the coupling unit 160. Details of the liquid introduction member 170 will be described later with reference to FIG. 4A and FIG. 4B and FIG. 5. The liquid lead-out member 140 has a function of leading out the liquid introduced by the liquid introduction member 170 to the liquid ejection apparatus 10. Details of the liquid lead-out member 140 will be described later with reference to FIG. 10A and FIG. 10B and FIG. 11A and FIG. 11B.

In the following, the dimensions illustrated in the drawings will be explained with reference to FIG. 2A and FIG. 2B and FIG. 3. In the present specification, the direction extending from the liquid lead-out member 140 to the spacer unit 150 (that is, the length direction) is defined as the +Y direction, the plane direction (that is, the width direction) orthogonal to the length direction is defined as the X direction, and the direction (that is, the height direction) orthogonal to the X direction and the Y direction is defined as the Z direction, respectively.

### <Liquid Containing Bag>

The liquid containing bag 120 described above internally contains liquid and has flexibility. Further, the liquid containing bag 120 is a pillow type bag of which two rectangular films are stacked and peripheral portions are adjoined by a method such as welding. The liquid containing bag 120 according to the present embodiment is composed of a laminate of multiple layers of a polyester layer, an aluminum layer, a nylon layer, or a polyethylene layer. For example, at least one of a deposition layer made of silica and an EVOH layer may be used for the films of the liquid containing bag 120. Further, other materials or configurations may be adopted according to the nature of the liquid or the quality required for the liquid.

### <Liquid Introduction Member>

Subsequently, the liquid introduction member 170 will be explained with reference to FIG. 4A and FIG. 4B to FIG. 7A and FIG. 7B. FIG. 4A and FIG. 4B are diagrams illustrating an outline of the liquid introduction member 170. FIG. 4A is a diagram of the liquid introduction member 170 viewed from the +Z direction (that is, a plan view of the liquid introduction member 170). As illustrated in FIG. 4A, the shape of the spacer unit 150 is quadrangular if viewed from the Z direction. The liquid introduction member 170 includes the spacer unit 150 and the coupling unit 160. The spacer unit 150 and the coupling unit 160 are integrally connected. The spacer unit 150 is arranged on the +Y direction side (that is, the base end side) of the liquid introduction member 170 relative to the coupling unit 160. The spacer unit 150 includes the first liquid intake port 151a and the second liquid intake port 151b (see FIG. 4B). The coupling unit 160 is formed with a flow path for connecting the spacer unit 150 and the liquid lead-out member 140 and letting the liquid taken from the spacer unit 150 flow to the liquid lead-out member 140.

FIG. 4B is a cross-sectional view taken along line IVb-IVb of FIG. 4A. As illustrated in FIG. 4B, the spacer unit 150 is in such a shape that the tip becomes sharper towards the +Y direction (that is, the base end side) if viewed from the X direction. The spacer unit 150 includes the first liquid intake port 151a (see FIG. 4A) and the second liquid intake port 151b.

The first liquid intake port 151a is arranged above the second liquid intake port 151b in the direction of gravity, so as to be capable of taking the liquid in the liquid containing bag 120 into the flow path in the coupling unit 160 from the +Z direction relative to the second liquid intake port 151b. On the other hand, the second liquid intake port 151b is capable of taking the liquid in the liquid containing bag 120 into the flow path in the coupling unit 160 relatively from the —Z direction as compared with the first liquid intake port 151a.

The liquid container 100 is mounted inside the liquid supply unit 15 (see FIG. 1) with the XY directions of FIG. 2A being a flat plane. Therefore, in a case where the liquid includes multiple components with different specific gravities, there is a possibility that, due to the precipitation of the components having a heavy specific gravity, the density of the liquid becomes thicker at the bottom of the liquid containing bag 120 and the density of the liquid becomes thinner at the upper part of the liquid containing bag 120. For example, in a case where the liquid is ink, due to the precipitation of the ink components, there may be such a situation where the ink density differs between the bottom (−Z direction side) of the liquid containing bag 120 and the upper part (+Z direction side) of the liquid containing bag 120.

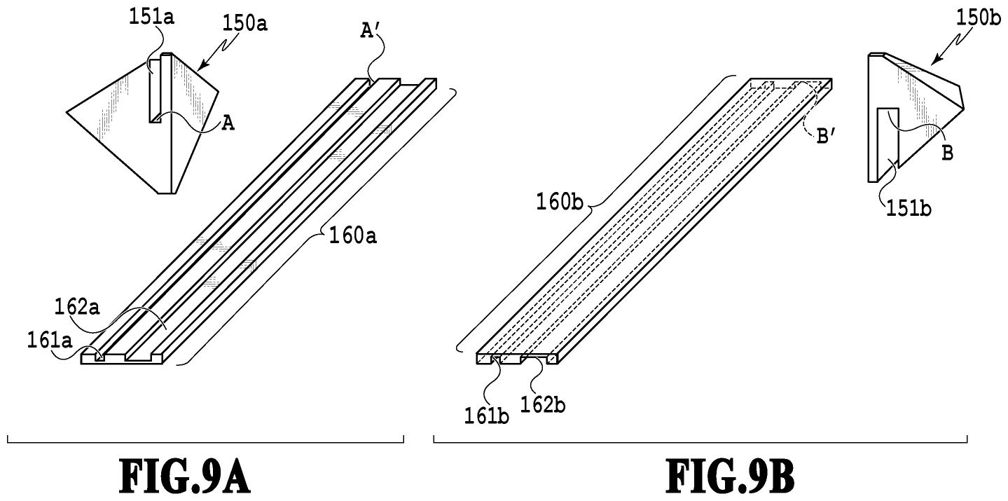

However, as in the present embodiment, by taking liquid from both of the +Z direction and the —Z direction and blending the liquid in the liquid storage unit 142 (see FIG. 9A), which will be described later, it is possible to eliminate the density difference of the liquid to be supplied to the liquid ejection apparatus 10. Note that, in a case where it is desired to change the density difference of the liquid, the size of the first liquid intake port 151a or the second liquid intake port 151b may be changed respectively.

### <Coupling Unit>

Subsequently, the coupling unit 160 will be explained with reference to FIG. 4A and FIG. 4B and FIG. 5. FIG. 5 is a cross-sectional view taken along line V-V of FIG. 4A. The coupling unit 160 is formed with the first flow path 161 for letting the liquid taken from the first liquid intake port 151a flow to the liquid lead-out member 140 and the second flow path 162 for letting the liquid taken from the second liquid intake port 151b flow to the liquid lead-out member 140.

The first flow path 161 and the second flow path 162 are formed by adjoining the later-described first coupling unit 160a and the later-described second coupling unit 160b so that the first coupling unit 160a and the second coupling unit 160b face each other. That is, the liquid taken from the first liquid intake port 151a flows through the first flow path 161. Further, the liquid taken from the second liquid intake port 151b flows through the second flow path 162.

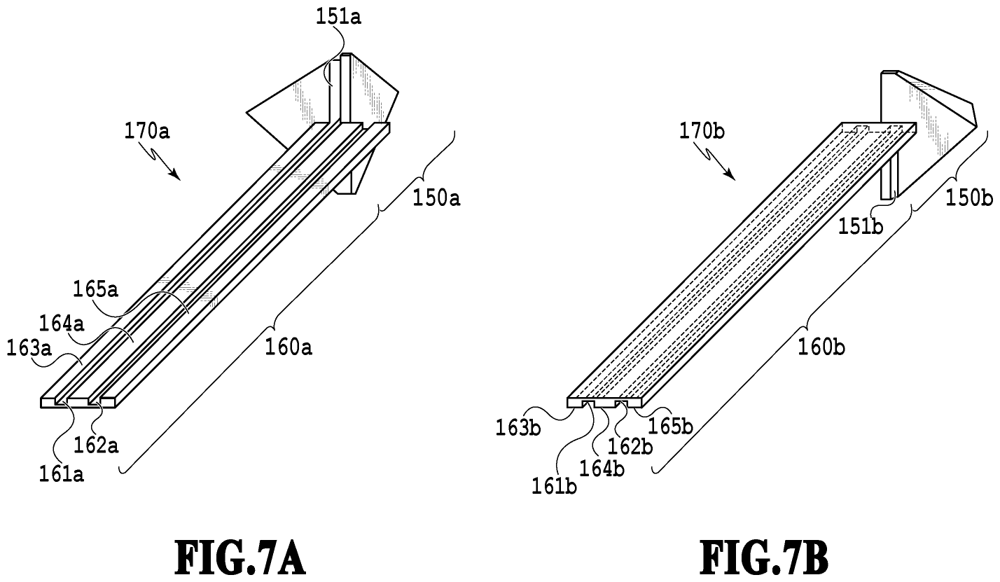

The later-described first groove 161a and second groove 162a (see FIG. 7A and FIG. 7B) are formed in parallel over the entire length of the first coupling unit 160a, and the later-described third groove 161b and the fourth groove 162b (see FIG. 7A and FIG. 7B) are formed in parallel over the entire length of the second coupling unit 160b. Therefore, the first flow path 161, which is formed with the first groove 161a and the third groove 161b, will be formed in parallel to the entire length of the coupling unit 160. Similarly, the second flow path 162, which is formed with the second groove 162a and the fourth groove 162b, will be formed in parallel to the entire length of the coupling unit 160.

Further, if the liquid introduction member 170 is viewed from the —Y direction side (that is, the tip side), the first opening 152a of the first liquid intake port 151a is formed at a position that is at least lower than the top part 153a of the later-described first spacer unit 150a, as illustrated in FIG. 5. That is, the heights of the left and right side walls of the first liquid intake port 151a are different from each other. This is to prevent the first liquid intake port 151a from being blocked by the liquid containing bag 120 that is gradually crushed by continuing liquid intake, which makes the liquid intake impossible. Accordingly, even if the liquid containing bag 120 is gradually crushed by continuing liquid intake, the space for taking the liquid is formed around the first liquid intake port 151a, so that the liquid intake can be continued.

Correspondingly, the second opening 152b of the second liquid intake port 151b is formed at a position that is at least higher than the lowest part 153b of the later-described second spacer unit 150b. That is, the heights of the left and right side walls of the second liquid intake port 151b are also different from each other. As described above, this is to secure the space for taking the liquid around the second liquid intake port 151b even if the liquid containing bag 120 is gradually crushed by continuing liquid intake, so that the liquid intake can be continued.

### (Modification Example of the Flow Path)

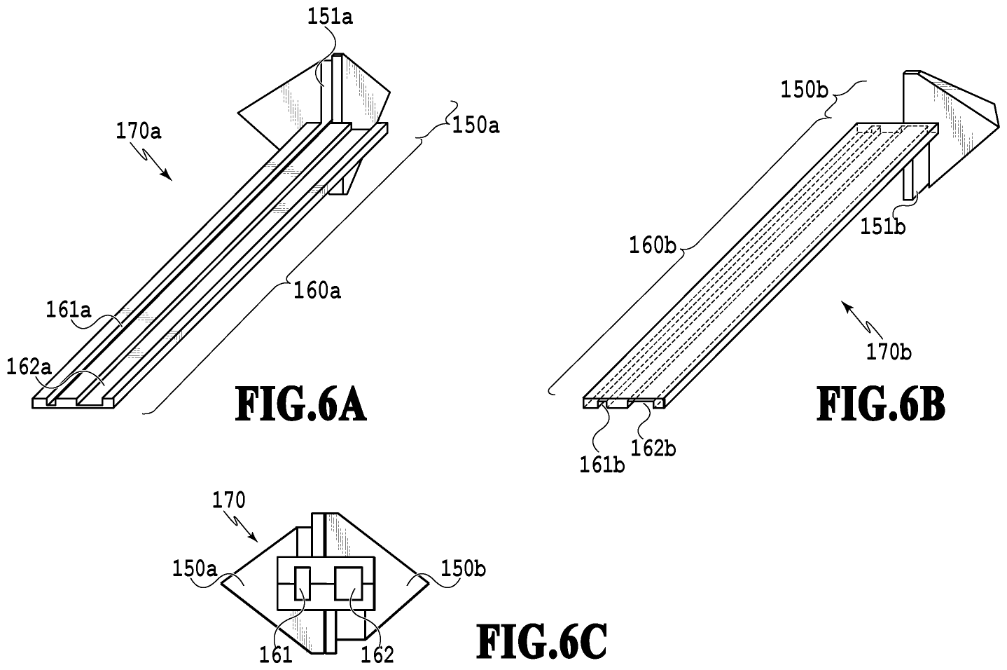

Although the example in which the shapes of the cross sections of the flow paths are quadrangular and the widths thereof are the same is illustrated in FIG. 5, the shapes of the flow paths are not limited to this example. For example, the shapes of the cross sections of the flow paths may be annular shapes or elliptical annular shapes. Further, for the purpose of adjusting the ink concentration by utilizing the shapes of the grooves, it is also possible to change the shapes of the respective grooves. For example, as illustrated in FIG. 6C which will be described later, the width of the first flow path 161 and the width of the second flow path 162 may be different from each other.

As one configuration example of the mechanism for eliminating the density difference due to the precipitation of the ink components, the widths of the flow paths for taking in the ink are made different. Accordingly, the blending ratio of the ink taken in from above and below can be changed, so that the blending density can be adjusted to a desired density. Hereinafter, the modification example of the flow paths will be explained with reference to FIG. 6A to FIG. 6C.

FIG. 6A to FIG. 6C are external perspective views illustrating an outline of another liquid introduction member of which the width of the first flow path 161 and the width of the second flow path 162 are different. In the example illustrated in FIG. 6A and FIG. 6B, the width of the second liquid intake port 151b is wider than the width of the first liquid intake port 151a. Further, the width of the second groove 162a is wider than the width of the first groove 161a. Furthermore, the width of the fourth groove 162b is wider than the width of the third groove 161b. Note that the details of the first groove 161a, the second groove 162a, the third groove 161b, and the fourth groove 162b will be described later with reference to FIG. 7A and FIG. 7B.

If the constituent parts (half-split bodies) illustrated in FIG. 6A and FIG. 6B are combined, the liquid introduction member 170 of which the width of the second flow path 162 is wider than the width of the first flow path 161 as illustrated in FIG. 6C is completed. Note that the details of the half-split bodies, the configuration of the liquid introduction member 170, and the manufacturing method of the liquid introduction member 170 will be described later with reference to FIG. 7A and FIG. 7B. Needless to say, depending on the desired blending density of the liquid, such a configuration in which the width of the first flow path 161 is wider than the width of the second flow path 162 is also possible.

Further, such a configuration in which grooves for making the cross section of the first flow path 161 quadrangle are formed and grooves for making the cross section of the second flow path 162 annular are formed is also possible.

### <Constituent Parts and Manufacturing Method of the Liquid Introduction Member>

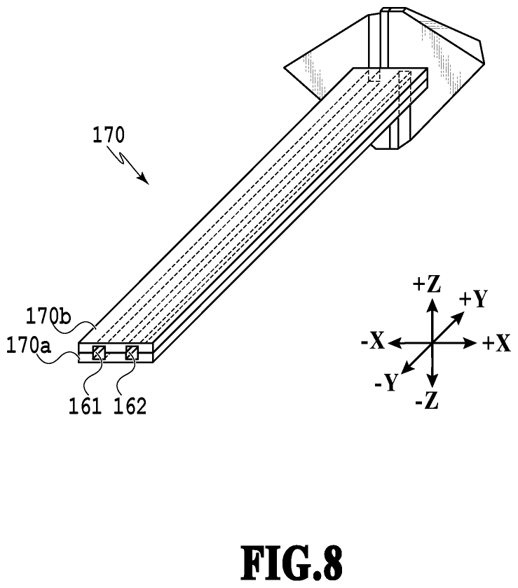

Subsequently, the constituent parts and the manufacturing method of the liquid introduction member 170 will be explained with reference to FIG. 7A and FIG. 7B and FIG. 8. FIG. 7A and FIG. 7B are external perspective views illustrating an outline of the constituent parts of the liquid introduction member 170. Hereinafter, the constituent parts illustrated in FIG. 7A and FIG. 7B are referred to as half-split bodies. The first half-split body 170a is illustrated in FIG. 7A, and the second half-split body 170b is illustrated in FIG. 7B. The liquid introduction member 170 is completed by assembling the first half-split body 170a and the second half-split body 170b. Further, in the present embodiment, the shapes of these two half-split bodies are the same. For molding the first half-split body 170a and the second half-split body 170b, the molding can be performed by parting the mold in the Z direction.

The first half-split body 170a is an integrally-molded part in which the first spacer unit 150a and the first coupling unit 160a are integrally configured. As described above, the first liquid intake port 151a is formed in the first spacer unit 150a. Further, in the first coupling unit 160a, the first groove 161a for forming the first flow path 161 and the second groove 162a for forming the second flow path 162 are formed. That is, after adjoining the first half-split body 170a and the second half-split body 170b so as to face each other, the first flow path 161 for letting the liquid taken from the liquid intake port 151a flow will be formed with the first groove 161a, which is formed continuously from the first liquid intake port 151a. On the other hand, after adjoining the first half-split body 170a and the second half-split body 170b so as to face each other, the second flow path 162 for letting the liquid taken from the second liquid intake port 151b flow will be formed with the second groove 162a. Further, the first groove 161a and the second groove 162a are formed in parallel over the entire length of the first coupling unit 160a.

The second half-split body 170b is an integrally-molded part in which the second spacer unit 150b and the second coupling unit 160b are integrally configured. As described above, the second liquid intake port 151b is formed in the second spacer unit 150b. Further, in the second coupling unit 160b, the third groove 161b for forming the first flow path 161 and the fourth groove 162b for forming the second flow path 162 are formed. That is, after adjoining the first half-split body 170a and the second half-split body 170b so as to face each other, the second flow path 162 for letting the liquid taken from the second liquid intake port 151b flow will be formed with the fourth groove 162b, which is formed continuously from the second liquid intake port 151b. On the other hand, after adjoining the first half-split body 170a and the second half-split body 170b so as to face each other, the first flow path 161 for letting the liquid taken from the first liquid intake port 151a flow will be formed with the third groove 161b. Further, the third groove 161b and the fourth groove 162b are formed in parallel over the entire length of the second coupling unit 160b.

FIG. 8 is an external perspective view illustrating an outline of the liquid introduction member 170 after assembling the half-split bodies. As described above, the liquid introduction member 170 is made by adjoining the first half-split body 170a and the second half-split body 170b so as to face each other. Further, the first half-split body 170a is arranged below the second half-split body 170b in the direction of gravity. Since the liquid introduction member 170 according to the present embodiment does not use a liquid lead-out pipe as a method for conveying liquid, it is not necessary to arrange a connection unit of a liquid lead-out pipe in the Y direction, which is advantageous for parting the mold.

The adjoining of the first half-split body 170a and the second half-split body 170b will be explained with reference to FIG. 7A and FIG. 7B. As for this adjoining, the first adjoining surface 163a and the fourth adjoining surface 163b, the second adjoining surface 164a and the fifth adjoining surface 164b, the third adjoining surface 165a and the sixth adjoining surface 165b are adjoined so as to face each other, respectively. The adjoining is performed, for example, by ultrasonic welding. If the adjoining is completed, the first flow path 161 is formed with the first groove 161a and the third groove 161b. Similarly, the second flow path 162 is formed with the second groove 162a and the fourth groove 162b.

Although the first half-split body 170a and the second half-split body 170b are adjoined by ultrasonic welding in the present embodiment, the adjoining may be performed by use of an adhesive agent or the like. Note that, although the first spacer unit 150a and the second spacer unit 150b are not adjoined in the present embodiment, the first spacer unit 150a and the second spacer unit 150b may be adjoined in a case where the fixation is unstable, etc.

### (Modification Example of the Half-split Bodies)

Although the first half-split body 170a and the second half-split body 170b have the same shape in the present embodiment, the first half-split body 170a and the second half-split body 170b are not limited to such a configuration as illustrated in FIG. 6A to FIG. 6C and may have various shapes as long as the liquid taken from the first liquid intake port 151a and the second liquid intake port 151b can be introduced to the liquid lead-out member 140. Hereinafter, a modification example of the half-split bodies will be explained with reference to FIG. 9A and FIG. 9B.

FIG. 9A and FIG. 9B are external perspective views illustrating an outline of constituent parts of another liquid introduction member.

For example, as illustrated in FIG. 9A, it is also possible that the first spacer unit 150a, which configures the above-described first half-split body 170a (see FIG. 7A and FIG. 7B), and the first coupling unit 160a are configured to be separate members. Further, as illustrated in FIG. 9B, it is also possible that the second spacer unit 150b, which configures the above-described second half-split body 170b (see FIG. 7A and FIG. 7B), and the second coupling unit 160b are configured to be separate members.

In a case where the first spacer unit 150a and the first coupling unit 160a are separate members, the lower end part of the first liquid intake port 151a (the part indicated as A) and the base end part of the first groove 161a (the part indicated as A′) are combined.

On the other hand, in a case where the second spacer unit 150b and the second coupling unit 160b are separate members, the upper end part of the second liquid intake port 151b (the part indicated as B) and the base end part of the fourth groove 162b (the part indicated as B′) are combined.

By making the respective parts be separate members in this way, it is possible to easily select the combination of an intake port and a flow path according to the type of liquid to be used, the required blending ratio of the liquid, etc.

### <Liquid Lead-Out Member>

Subsequently, the liquid lead-out member 140 will be explained with reference to FIG. 10A and FIG. 10B and FIG. 11A and FIG. 11B. FIG. 10A and FIG. 10B are diagrams illustrating an outline of the liquid lead-out member 140. FIG. 10A is a diagram (that is, a plan view) of the liquid lead-out member 140 viewed from the +Z direction. FIG. 10B is a diagram of the liquid lead-out member 140 viewed from the —Y direction (that is, the tip side). FIG. 11A and FIG. 11B are cross-sectional views illustrating an outline of the liquid lead-out member 140. FIG. 11A is a cross-sectional view taken along line IX-IX of FIG. 10B. FIG. 11B is a cross-sectional view taken along line IX-IX, in which the liquid lead-out member 140 pierced with the needle 40 is illustrated.

As illustrated in FIG. 11A, the liquid lead-out member 140 includes the adjoining space 141 to which the coupling unit 160 is adjoined, the liquid storage unit 142, the spring 143, the check valve 144, and the rubber packing 145. The tip of the coupling unit 160 is mounted on the adjoining space 141, and thereby the liquid introduction member 170 is adjoined to the liquid lead-out member 140. Note that the method of adjoining the liquid lead-out member 140 and the coupling unit 160 may be engagement, or the liquid lead-out member 140 and the coupling unit 160 may be adjoined by use of an adhesive agent. In the liquid storage unit 142, the low-density liquid that has flown through the first flow path 161 and the high-density liquid that has flown through the second flow path 162 are blended, and thereby the density of the liquid becomes constant. Accordingly, it becomes possible to supply liquid having a stable density to the liquid ejection apparatus 10.

Subsequently, the connection between the liquid ejection apparatus 10 and the liquid lead-out member 140 will be explained with reference to FIG. 11B. As described above, the liquid lead-out member 140 includes the spring 143, the check valve 144, and the rubber packing 145. For mounting the liquid container 100 on the liquid ejection apparatus 10, the metal needle 40 having a flow path formed in the center thereof is mounted at a position where the liquid container 100 is mounted on the main body of the liquid ejection apparatus 10.

If the liquid container 100 is connected to the main body of the liquid ejection apparatus 10, the needle 40 penetrates the rubber packing 145 which is mounted on the liquid container 100. Then, the check valve 144 is pushed down by the needle 40, so that the liquid in the liquid lead-out member 140 is supplied to the main body of the liquid ejection apparatus 10 through the flow path formed in the needle 40. Further, if the liquid container 100 is removed from the main body of the liquid ejection apparatus 10, the needle 40 is pulled out and the spring 143 is extended, so that the check valve 144 is closed and the supply of the liquid is stopped.

The liquid lead-out member 140 according to the present embodiment is divided along IX-IX line of FIG. 10B. Further, after installing the spring 143 and the check valve 144 to the inside, the cross sections of IX-IX line are adjoined to each other, and the rubber packing 145 is adhered to the opening of the liquid lead-out member 140. Further, an enclosed space is created by welding the liquid containing bag 120 to the periphery of the outer wall of the liquid lead-out member 140. Furthermore, the liquid is sealed in the enclosed space, and then the liquid container 100 is completed.

Thereby, it is possible to provide a liquid container capable of supplying liquid to a liquid ejection apparatus with a simple configuration.

### Second Embodiment

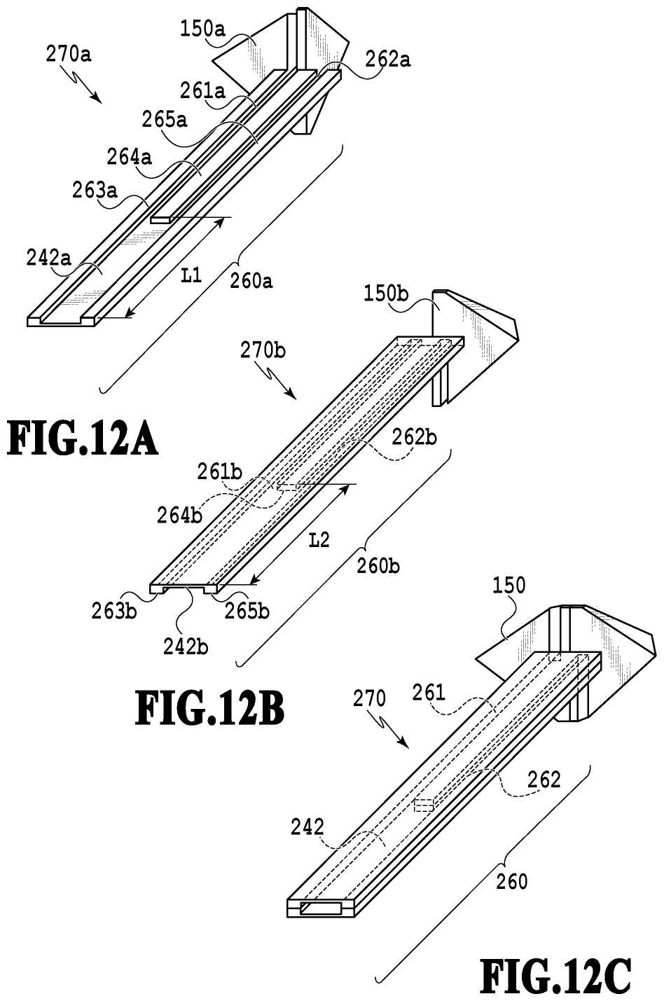

The second liquid introduction member 270 according to the second embodiment will be explained with reference to FIG. 12A to FIG. 14. In the first embodiment, the liquid storage unit 142 is formed in the liquid lead-out member 140. On the other hand, in the present embodiment, the second liquid storage unit 242 is formed in the coupling unit 260. The following explanation focuses on the aspects that are different from the first embodiment, and the same configurations as those of the first embodiment are assigned with the same signs and the explanations thereof are omitted.

FIG. 12A to FIG. 12C are diagrams illustrating an outline of the second liquid introduction member 270. FIG. 12A is an external perspective view illustrating an outline of the third half-split body. FIG. 12B is an external perspective view illustrating an outline of the fourth half-split body. FIG. 12C is an external perspective view illustrating an outline of the second liquid introduction member 270.

As illustrated in FIG. 12A, the third coupling unit 260a of the third half-split body 270a is formed with the fifth groove 261a, the sixth groove 262a, the seventh joint surface 263a, the first partition 264a which also serves as the eighth joint surface, and the ninth joint surface 265a. Further, the first liquid storage space 242a is formed at the tip of the third coupling unit 260a, and, in FIG. 12A, the length of the first liquid storage space 242a is indicated as “L1”.

The fifth groove 261a is a groove for letting the liquid taken from the first liquid intake port 151a flow to the first liquid storage space 242a. Further, the sixth groove 262a is a groove for letting the liquid taken from the second liquid intake port 151b flow to the first liquid storage space 242a.

The first partition 264a is a partition formed between the fifth groove 261a and the sixth groove 262a. Since the first partition 264a does not extend to the end part of the third coupling unit 260a (that is, the tip of the third coupling unit 260a) that is on the opposite side of the end part to be connected to the first spacer unit 150a, there is a space at the tip of the third coupling unit 260a. This space is the first liquid storage space 242a.

As illustrated in FIG. 12B, the fourth coupling unit 260b of the fourth half-split body 270b is formed with the seventh groove 261b, the eighth groove 262b, the tenth joint surface 263b, the second partition 264b which also serves as the eleventh joint surface, and the twelfth joint surface 265b. Further, the second liquid storage space 242b is formed at the tip of the fourth half-split body 270b, and, in FIG. 12B, the length of the second liquid storage space 242b is indicated as “L2”.

The seventh groove 261b is a groove for letting the liquid taken from the first liquid intake port 151a flow to the second liquid storage space 242b. Further, the eighth groove 262b is a groove for letting the liquid taken from the second liquid intake port 151b flow to the second liquid storage space 242b.

The second partition 264b is a partition formed between the seventh groove 261b and the eighth groove 262b. Since the second partition 264b does not extend to the end part of the fourth coupling unit 260b (that is, the tip of the fourth coupling unit 260b) that is on the opposite side of the end part to be connected to the second spacer unit 150b, there is a space at the tip of the fourth coupling unit 260b. This space is the second liquid storage space 242b.

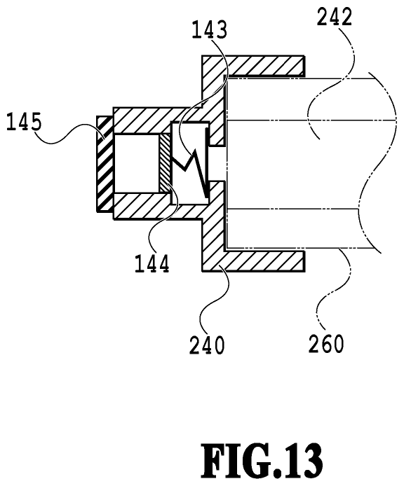

The manufacturing method of the second liquid introduction member 270 will be explained below. First, the spring 143 and the check valve 144 are installed on the later-described second liquid lead-out member 240 (see FIG. 13). Further, the seventh joint surface 263a and the tenth joint surface 263b, the first partition 264a and the second partition 264b, and the ninth joint surface 265a and the twelfth joint surface 265b are adjoined so as to face each other, respectively. If the adjoining is completed, the second liquid introduction member 270 is formed, and the third flow path 261 is formed with the fifth groove 261a and the seventh groove 261b as illustrated in FIG. 12C. Similarly, the fourth flow path 262 is formed with the sixth groove 262a and the eighth groove 262b.

If the third half-split body 270a and the fourth half-split body 270b are adjoined, the second liquid storage unit 242 is formed with the first liquid storage space 242a and the second liquid storage space 242b. This second liquid storage unit 242 corresponds to the liquid storage unit 142 formed in the liquid lead-out member 140 according to the first embodiment. That is, in the second liquid storage unit 242, the low-density liquid that has flown through the third flow path 261 and the high-density liquid that has flown through the fourth flow path 262 are blended, and thereby the density of the liquid becomes constant. Thus, it becomes possible to supply liquid having a stable density to the liquid ejection apparatus 10.

FIG. 13 is a cross-sectional view of the second liquid lead-out member 240 according to the present embodiment. Note that the cutting line of the cross-sectional view is the same as that of the first embodiment. Since the space (that is, the second liquid storage unit 242) corresponding to the liquid storage unit 142 according to the first embodiment exists in the coupling unit 260, it is not necessary to form a liquid storage unit in the second liquid lead-out member 240. Therefore, in the present embodiment, the liquid conveyance member can be downsized than that in the first embodiment.

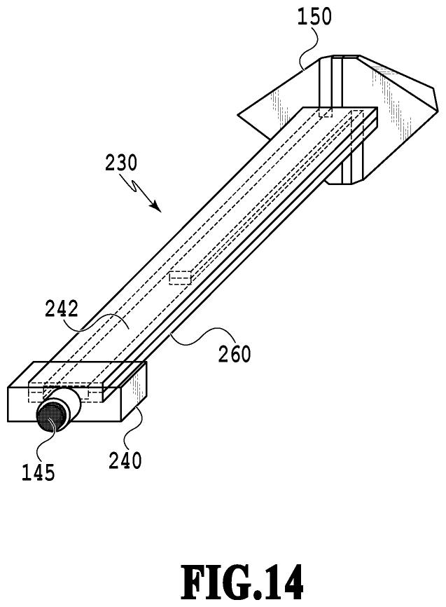

FIG. 14 is an external perspective view illustrating an outline of the second liquid conveyance member 230 in the present embodiment. If the second liquid lead-out member 240 is mounted on the second liquid introduction member 270, the second liquid conveyance member 230 is formed. The second liquid storage unit 242 is formed in the coupling unit 260 of the second liquid conveyance member 230. Further, by changing the length of the second liquid storage unit 242, the second liquid storage unit 242 can be enlarged within a range in which the density difference of the liquid will not be significant.

### Third Embodiment

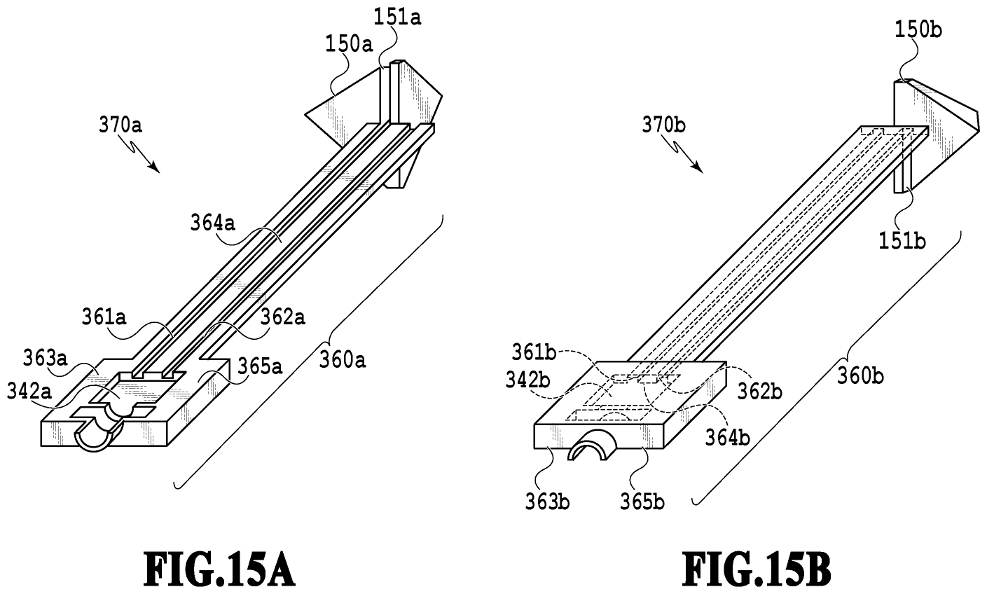

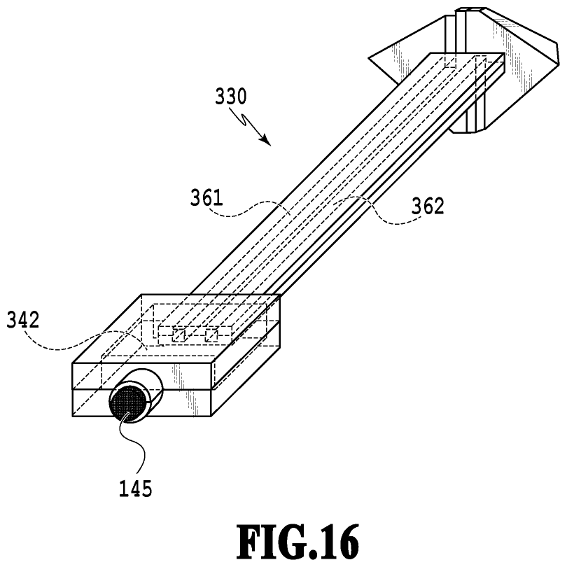

The third liquid conveyance member 330 according to the third embodiment will be explained with reference to FIG. 15A and FIG. 15B and FIG. 16.

The difference between the liquid conveyance member 130 in the first embodiment and the third liquid conveyance member 330 in the present embodiment will be explained. In the first embodiment, the liquid introduction member 170 and the liquid lead-out member 140 are separate members. On the other hand, the present embodiment is different from the first embodiment in the aspect that the coupling unit and the liquid lead-out unit are integrally molded. The following explanation focuses on the aspects that are different from the first embodiment, and the same configurations as those of the first embodiment are assigned with the same signs and the explanations thereof are omitted.

FIG. 15A and FIG. 15B are external perspective views illustrating an outline of the half-split bodies according to the present embodiment. FIG. 15A is an external perspective view illustrating an outline of the fifth half-split body. As illustrated in FIG. 15A, the fifth coupling unit 360a of the fifth half-split body 370a is formed with the ninth groove 361a, the tenth groove 362a, the thirteenth joint surface 363a, the fourteenth joint surface 364a, the fifteenth joint surface 365a, and the third liquid storage space 342a. The ninth groove 361a is a groove for letting the liquid taken from the first liquid intake port 151a flow to the third liquid storage space 342a. Further, the tenth groove 362a is a groove for letting the liquid taken from the second liquid intake port 151b flow to the third liquid storage space 342a. Since a liquid introduction unit is included in the fifth coupling unit 360a according to the present embodiment, the fifth coupling unit 360a has a structure in which a spacer unit, a coupling unit, and a liquid lead-out unit are integrated. That is, the first liquid intake port 151a, the ninth groove 361a, and the third liquid storage space 342a are continuously formed.

FIG. 15B is an external perspective view illustrating an outline of the sixth half-split body. As illustrated in FIG. 15B, the sixth coupling unit 360b of the sixth half-split body 370b includes the eleventh groove 361b, the twelfth groove 362b, the sixteenth joint surface 363b, the seventeenth joint surface 364b, the eighteenth joint surface 365b, and the fourth liquid storage space 342b. The eleventh groove 361b is a groove for letting the liquid taken from the first liquid intake port 151a flow to the fourth liquid storage space 342b. Further, the twelfth groove 362b is a groove for letting the liquid taken from the second liquid intake port 151b flow to the fourth liquid storage space 342b. Further, since a liquid introduction unit is included in the sixth coupling unit 360b according to the present embodiment, the sixth coupling unit 360b has a structure in which a spacer unit, a coupling unit, and a liquid lead-out unit are integrated. That is, the second liquid intake port 151b, the eleventh groove 361b, and the fourth liquid storage space 342b are continuously formed.

FIG. 16 is an external perspective view illustrating an outline of the third liquid conveyance member 330. The manufacturing method of the third liquid conveyance member 330 illustrated in FIG. 16 will be explained below. First, the spring 143 and the check valve 144 are installed on either the fifth half-split body 370a or the sixth half-split body 370b. Further, the thirteenth joint surface 363a, the fourteenth joint surface 364a, and the fifteenth joint surface 365a which are illustrated in FIG. 15A and the sixteenth joint surface 363b, the seventeenth joint surface 364b, and the eighteenth joint surface 365b which are illustrated in FIG. 15B are adjoined so as to face each other, respectively. If the adjoining is completed, the third liquid conveyance member 330 is formed, and the fifth flow path 361 is formed with the ninth groove 361a and the eleventh groove 361b as illustrated in FIG. 16. Similarly, the sixth flow path 362 is formed with the tenth groove 362a and the twelfth groove 362b. After the fifth half-split body 370a and the sixth half-split body 370b are adjoined, the third liquid storage unit 342 is formed with the third liquid storage space 342a and the fourth liquid storage space 342b. Then, the third liquid conveyance member 330 is completed by adhering the rubber packing 145 to the opening of the liquid lead-out unit.

According to the present embodiment, the number of parts is reduced as compared with the first embodiment, so that the number of steps for the assemblage can be reduced.

### Fourth Embodiment

The following explanation focuses on the aspects that are different from the first embodiment, and the explanations of the same configurations as those of the first embodiment are omitted.

In the first embodiment, the first groove 161a and the second groove 162a are formed in parallel over the entire length of the coupling unit 160. On the other hand, the present embodiment is different from the first embodiment in the aspect that the second groove 162a is not formed.

In the present embodiment, at the time of forming the grooves in the half-split bodies, although the first groove 161a, which is formed continuously from the first liquid intake port 151a, is formed over the entire length of the coupling unit, the second groove 162a for letting the liquid taken from the second liquid intake port 151b flow is not formed. Further, the half-split bodies having the same shape in which the first groove 161a is formed are adjoined so that the adjoining surfaces face each other.

According to the present embodiment, since the number of grooves to be formed is less than that of the first embodiment, the number of steps for the assemblage can be reduced.

### Fifth Embodiment

The following explanation focuses on the aspects that are different from the first embodiment, and the explanations of the same configurations as those of the first embodiment are omitted.

The difference between the half-split bodies in the first embodiment and the half-split bodies in the present embodiment will be explained. In both of the first half-split body 170a and the second half-split body 170b of the first embodiment, the first groove 161a and the second groove 162a are formed in parallel over the entire length of the coupling unit 160. On the other hand, the present embodiment is different from the first embodiment in the aspect that the second groove 162a is formed only in either the first half-split body 170a or the second half-split body 170b. For example, although the first groove 161a and the second groove 162a are formed in the first half-split body 170a, the fourth groove 162b is formed and the third groove 161b is not formed in the second half-split body 170b. Further, the first half-split body 170a and the second half-split body 170b are adjoined so that their joint surfaces face each other.

According to the present embodiment, since the number of grooves to be formed is less than that of the first embodiment, the number of steps for the assemblage can be reduced.

According to the technique of the present disclosure, it is possible to provide a liquid container capable of supplying liquid to a liquid ejection apparatus with a simple configuration.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-087565, filed May 25, 2021 which are hereby incorporated by reference wherein in its entirety.

What is claimed is:

1. A liquid container comprising:
a liquid containing bag configured to contain liquid; and
an introduction member arranged inside the liquid containing bag for introducing the liquid to a liquid lead-out unit,
wherein the introduction member includes a first liquid introduction member and a second liquid introduction member which is adjoined to the first liquid introduction member,
wherein the first liquid introduction member is equipped with a first spacer unit, in which a first liquid intake port for taking the liquid is formed, and a first coupling unit, which is integrally connected to the first spacer unit and in which a first groove for letting the liquid taken from the first liquid intake port flow to the liquid lead-out unit is formed,
wherein the second liquid introduction member is equipped with a second spacer unit, in which a second liquid intake port for taking the liquid is formed, and a second coupling unit, which is integrally connected to the second spacer unit and in which a second groove for letting the liquid taken from the second liquid intake port flow to the liquid lead-out unit is formed, and
wherein the first liquid introduction member and the second liquid introduction member are adjoined so that a surface on which the first groove is formed and a surface on which the second groove is formed face each other.

2. The liquid container according to claim 1,
wherein the first groove and the second groove are formed over an entire length of the first coupling unit.

3. The liquid container according to claim 1,
wherein the first liquid intake port is arranged above the second liquid intake port in a direction of gravity,
wherein an opening of the first liquid intake port is formed at a position that is at least lower than a top part of the first spacer unit, and
wherein an opening of the second liquid intake port is formed at a position that is at least higher than a lowest part of the second spacer unit.

4. The liquid container according to claim 1,
wherein a third groove for letting the liquid taken from the second liquid intake port flow is formed in the first coupling unit.

5. The liquid container according to claim 4,
wherein the third groove is formed over an entire length of the first coupling unit.

6. The liquid container according to claim 1,
wherein a fourth groove for letting the liquid taken from the first liquid intake port flow is formed in the second coupling unit.

7. The liquid container according to claim 6,
wherein the fourth groove is formed over an entire length of the second coupling unit.

8. The liquid container according to claim 3,
wherein, in the first coupling unit, a first space for storing the liquid taken from the first liquid intake port and the second liquid intake port is formed.

9. The liquid container according to claim 3,
wherein, in the second coupling unit, a second space for storing the liquid taken from the first liquid intake port and the second liquid intake port is formed.

10. The liquid container according to claim 1 further comprising the liquid lead-out unit,
wherein the liquid lead-out unit has a space for storing liquid which is taken from the first liquid intake port and the second liquid intake port and has flown through the first coupling unit and the second coupling unit.

11. The liquid container according to claim 10,
wherein the liquid lead-out unit is configured with a first liquid lead-out unit and a second liquid lead-out unit,
wherein the first liquid lead-out unit is integrally connected to the first coupling unit, and
wherein the second liquid lead-out unit is integrally connected to the second coupling unit.

12. An introduction member arranged inside a liquid containing bag for introducing liquid to a liquid lead-out unit,
wherein the introduction member includes a first liquid introduction member and a second liquid introduction member which is adjoined to the first liquid introduction member,
wherein the first liquid introduction member is equipped with a first spacer unit, in which a first liquid intake port for taking the liquid is formed, and a first coupling unit, which is integrally connected to the first spacer unit and in which a first groove for letting the liquid taken from the first liquid intake port flow to the liquid lead-out unit is formed,
wherein the second liquid introduction member is equipped with a second spacer unit, in which a second liquid intake port for taking the liquid is formed, and a second coupling unit, which is integrally connected to the second spacer unit and in which a second groove for letting the liquid taken from the second liquid intake port for taking the liquid flow to the liquid lead-out unit is formed, and
wherein the first liquid introduction member and the second liquid introduction member are adjoined so that a surface on which the first groove is formed and a surface on which the second groove is formed face each other.
